(19) United States
(12) Patent Application Publication
(10) Pub. No.: US 2015/0097098 A1
(43) Pub. Date: Apr. 9, 2015

(54) STEEL COIL PROTECTION STRUCTURE

(71) Applicant: Jimmy CHI, Fremont, CA (US)

(72) Inventor: Jimmy CHI, Fremont, CA (US)

(21) Appl. No.: 14/045,317

(22) Filed: Oct. 3, 2013

(51) Int. Cl. F16M 13/00

(52) U.S. Cl. CPC F16M 13/00
USPC 248/346.5

(57) ABSTRACT

A steel coil protection structure supports a steel coil stably, keeping it from dropping to affect road safety or endanger lives of operators. The protection structure includes a bottom seat, foundation units, side seats and carrier blocks. The bottom seat is a quadrilateral plate and each end side thereof is the foundation unit, forming a gap between the foundation units. Each end side of the foundation unit is the side seat, tilted deliberately toward a center to form a bevel. An exterior side of the side seat includes a recess, facilitating users to transport the protection structure. The carrier blocks are fixed above the side seats and have an excellent slide-proofing and vibration-absorption effect to truly locate the steel coil on the protection structure, preventing the steel coil from sliding to cause danger. Each part is replaced separately when damaged, thereby achieving a better performance of use,

### BACKGROUND OF THE INVENTION

(a) Field of the Invention

The present invention relates to a steel coil protection structure, and more particularly to a steel coil protection structure that is provided with a bottom seat, wherein two end sides of the bottom seat are stacked with foundation units, side seats and carrier blocks. A gap is formed between the two foundation units to stabilize the steel coil that is emplaced on the foundation units, so that the steel coil will not escape, thereby improving safety of transporting the steel coil. In addition, each part can be replaced independently to save the cost of renewing the entire protection structure.

(b) Description of the Prior Art

A steel coil is formed by wrapping steel in a shape of a plate or a strip on a reel. Therefore, the steel coil itself will be formed like a cylinder. In addition, the steel coil weighs about 30 tons. Accordingly, the steel coil can be only hoisted or transported by tools, which is a dangerous operation. In particular, as the steel coil is a cylinder, it should be secured truly while handling or transporting the steel coil, in order to prevent the steel coil from dropping in transportation to affect road safety or endanger lives of operators in hoisting or handling the steel coil.

An early method for securing the steel coil is to provide timber seats in a metal frame. The timber seats are provided with carrier bevels capable of abutting and supporting to stably support the steel coil. However, as the timber seats are made of wood, they cannot withstand too large an external force and the timber seats should be cut into formation in advance, which wastes time and labor works in manufacturing. In addition, the failure rate can be extremely high. In particular, as the wood is not flexible, scratches can be formed easily that the business loss of the steel coil can be excessively high. Furthermore, as insects can hide easily in the wood, drugs should be given to expel and terminate the insects prior to making the timber seats, which even increases the cost of making the timber seats.

Referring to FIG. 1, two existing support seats 1 are disposed below a front and rear end of a steel coil 10 (as shown in FIG. 2) to support the steel coil 10, wherein a gap between the support seats 1 is adjusted according to the size of the steel coil 10. Although the steel coil 10 can be located on the support seats 1, the steel coil 10 can slide easily between the two support seats 1, which is considerably dangerous. Moreover, as the support seats 1 are formed integrally, they can be often fractured and damaged after being pressed heavily by the steel coil 10 for many times, resulting in that the support seats 1 can no longer be used and the entire set of the supporting seats 1 must be discarded away for renewing, which is a pity. Besides that, for the conventional support seats 1 (or timber seats), outer rings of the steel coil 10 can be deformed easily due to vibration or shaking in transportation, resulting in that the steel coil 10 cannot be used any longer, with an average business loss of about 5% (as shown in FIG. 3).

The inventor is specialized in the research and development, manufacturing and selling of the support seats of the steel coil, knowing very well that for the conventional seats of the steel coil, the attrition rate is high and parts cannot be replaced individually that not only the economic benefit is poor, but the cost is higher, in addition to that the performance of use is inferior and the risk is higher. Accordingly, by the expertise of the inventor himself and many years of work experiences, a steel coil protection structure is created after many times of modification, testing and improvement. The steel coil protection structure is provided with a high value of application as the parts can be replaced individually and the fixing effect is better.

### SUMMARY OF THE INVENTION

The present invention discloses a steel coil protection structure which is able to support the steel coil stably, preventing the steel coil from dropping to affect road safety or endanger lives of operators. The steel coil protection structure is formed primarily by a bottom seat, foundation units, side seats and carrier blocks. The bottom seat is a quadrilateral plate and two end sides of the bottom seat are provided respectively with the foundation unit, forming a gap between the two foundation units to distribute the weight of the steel coil, avoiding the weight to be concentrated that the protection structure can be damaged easily. Two end sides of the foundation unit are provided respectively with the side seat that is a triangular block. In addition, two side seats are tiled deliberately toward a center to from a bevel, so that the steel coil can be emplaced stably without shaking. An exterior side of the side seat is provided with a recess to facilitate users to transport the protection structure using the recess as a point of application, thereby expediting the transportation successfully. The carrier blocks made of a composite material are fixed above the bevels and are provided with an excellent slide-proofing and vibration-absorption effect, wherein the slide-proofing effect of surface friction can be utilized to truly locate the steel coil on the protection structure that the steel coil will not escape from the protection structure due to shaking in transportation. Therefore, the steel coil can be effectively prevented from sliding to cause danger, and will not be damaged by the vibration-absorption effect. Furthermore, as the present invention is formed by assembling all parts, when a part is damaged, it can be replaced separately without renewing the entire protection structure, thereby saving the cost of replacement and achieving a better economic benefit.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a prior art in use.

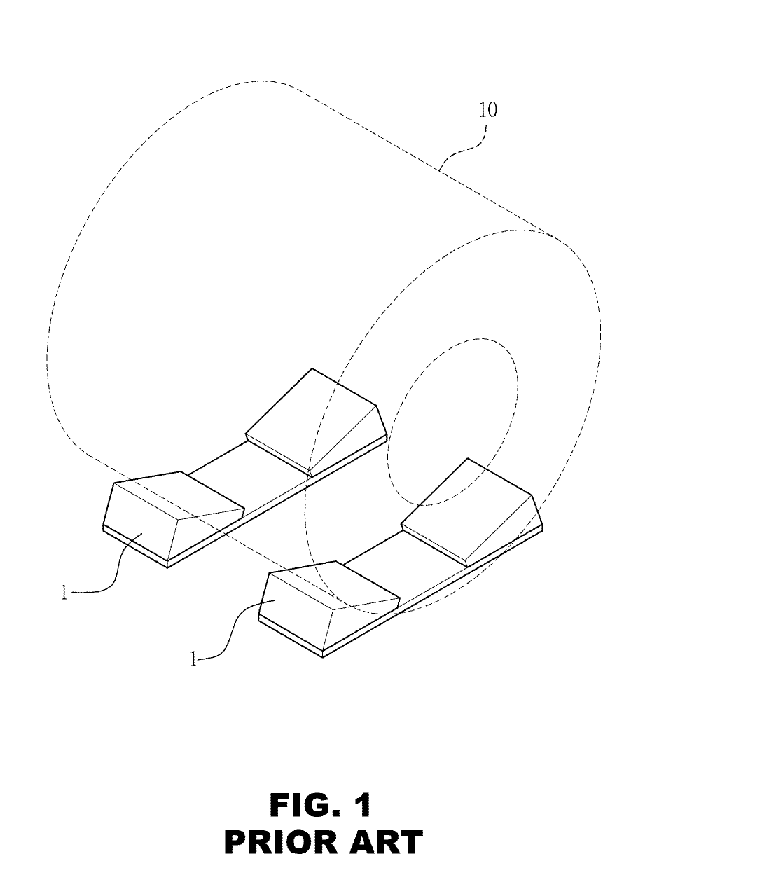

FIG. 2 shows a schematic view of the prior art which supports a steel coil.

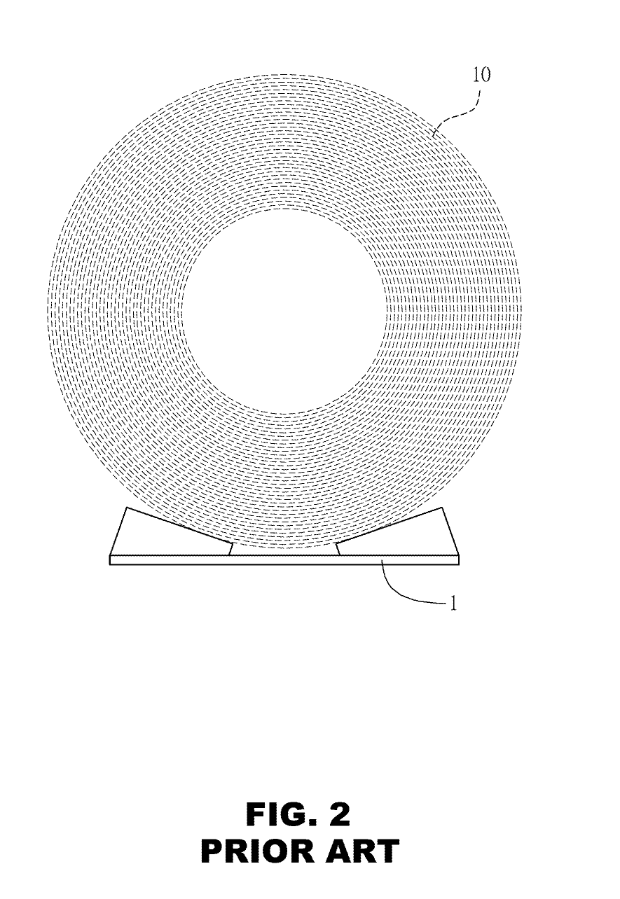

FIG. 3 shows a schematic view of a business loss incurred in transporting a steel coil supported by the prior art.

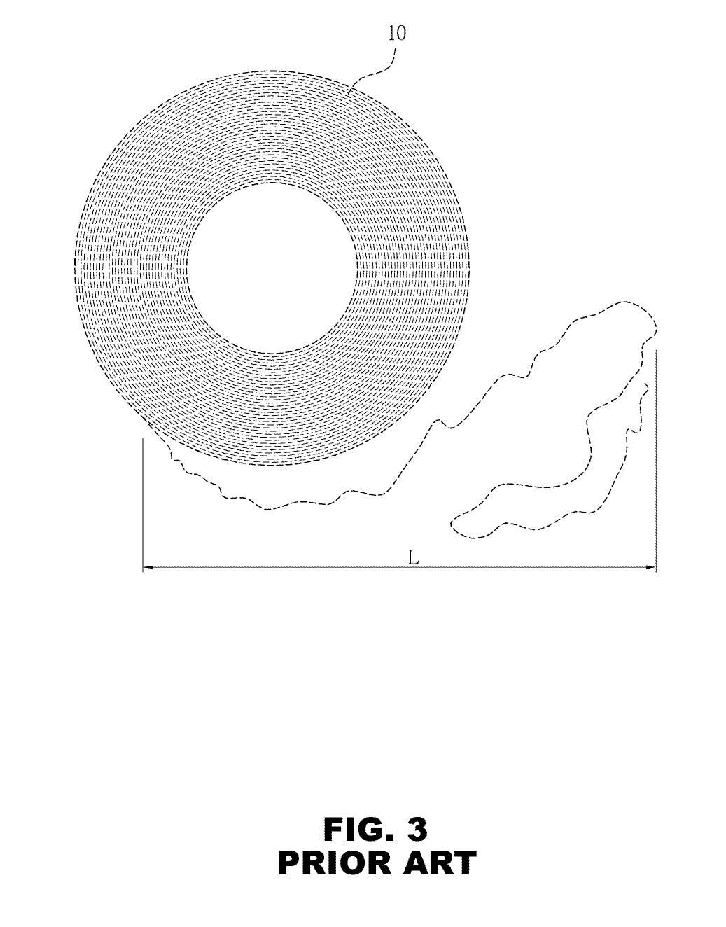

FIG. 4 shows a three-dimensional exploded view of the present invention.

FIG. 5 shows a schematic view of the present invention in use.

FIG. 6 shows a schematic view of the present invention which supports a steel coil.

FIG. 7 shows a front cutaway view of the present invention.

FIG. 8 shows a schematic view of the present invention in transportation.

### DETAILED DESCRIPTION OF THE PREFERRED EMBODIMENTS

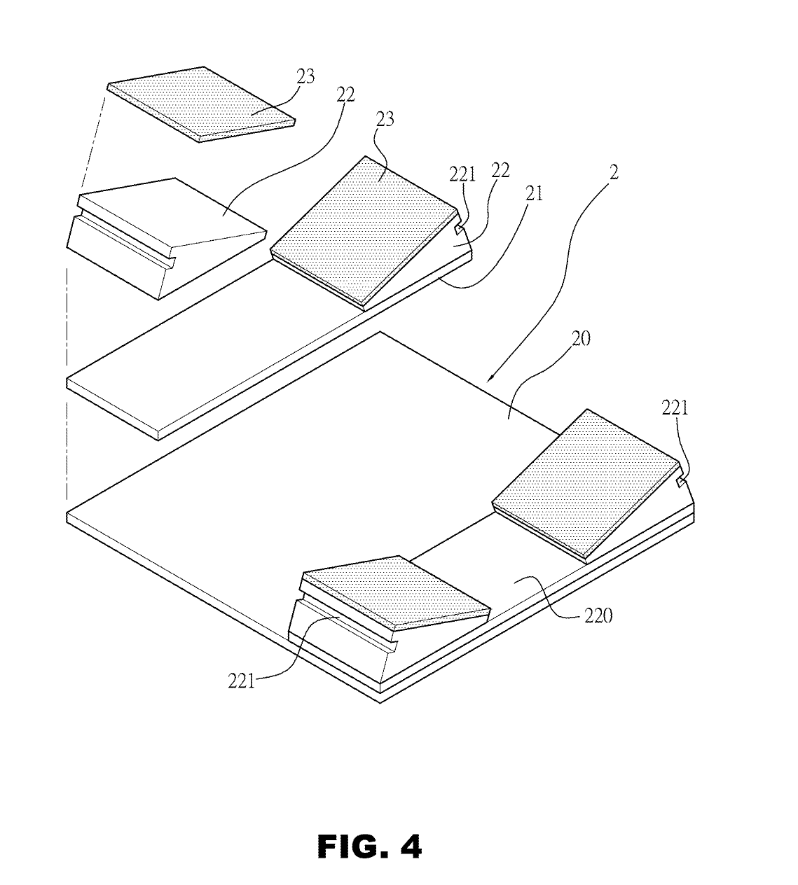

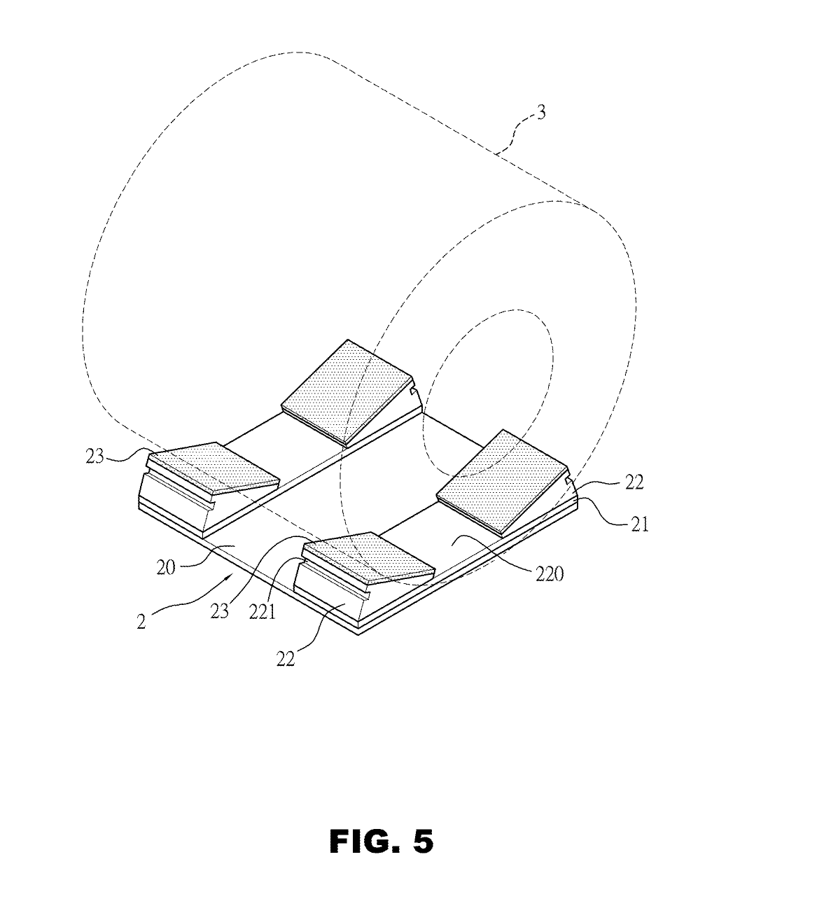

Referring to FIG. 4 and FIG. 5, it shows a three-dimensional exploded view of the present invention. A steel coil protection structure 2, according to the present invention, comprises primarily a bottom seat 20, foundation units 21, side seats 22 and carrier blocks 23. The bottom seat 20 is a quadrilateral plate and two end sides of the bottom seat 20 are provided respectively with the foundation unit 21, forming a gap between the two foundation units 21 to distribute the weight of the steel coil 3. Two end sides of the foundation unit 21 are provided respectively with the side seat 22 that is a triangular block. The two side seats 22 are tilted deliberately toward a center to form a bevel, forming a positioning groove 220 between the two side seats 22, such that the steel coil 3 can be fixed in the positioning groove 220 without shaking. In addition, an exterior side of each side seat 22 is provided with a recess 221 to facilitate users to transport the protection structure 2 using the recess 221 as a point of application. An upper side of the side seat 22 is fixed with the carrier block 23 that is made of a composite material (such as plastic, plastic mixture or plastic polymer) and is provided with an excellent slide-proofing and vibration-absorption effect.

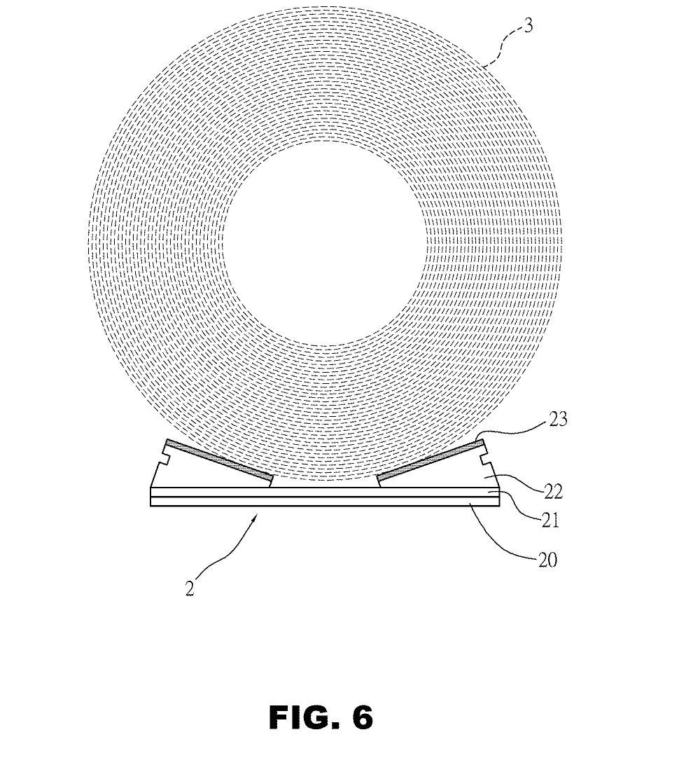

Referring to FIG. 5, when using the present invention, the steel coil 3 is located on the protection structure 2 and a positioning groove 220 is formed between the two side seats 22, such that the center of gravity of the steel coil 3 can be concentrated in the positioning groove 220. In addition, the weight of the steel coil 3 can be uniformly supported by the inward bevels of the two side seats 22. Besides that, the diameter of the steel coil 3 is larger than the size of the two side seats 22 (as shown in FIG. 6), allowing the steel coil 3 to be located stably on the protection structure 2 without shaking easily. By that the carrier block 23 is made of a slide-proofing and flexible material, a friction force can be formed between the carrier block 23 and the steel coil 3 that the steel coil 3 can be stably fixed on the carrier block 23 without sliding. Therefore, the slide-proofing effect is excellent. In particular, as the carrier block 23 is made of a composite material (such as plastic, plastic mixture or plastic polymer), it can buffer a large force of gravity which is supported by the protection structure 2, preventing the protection structure 2 from being fractured or damaged, and being provided with an excellent vibration-absorption or vibration-proofing effect to assure safety of transportation,

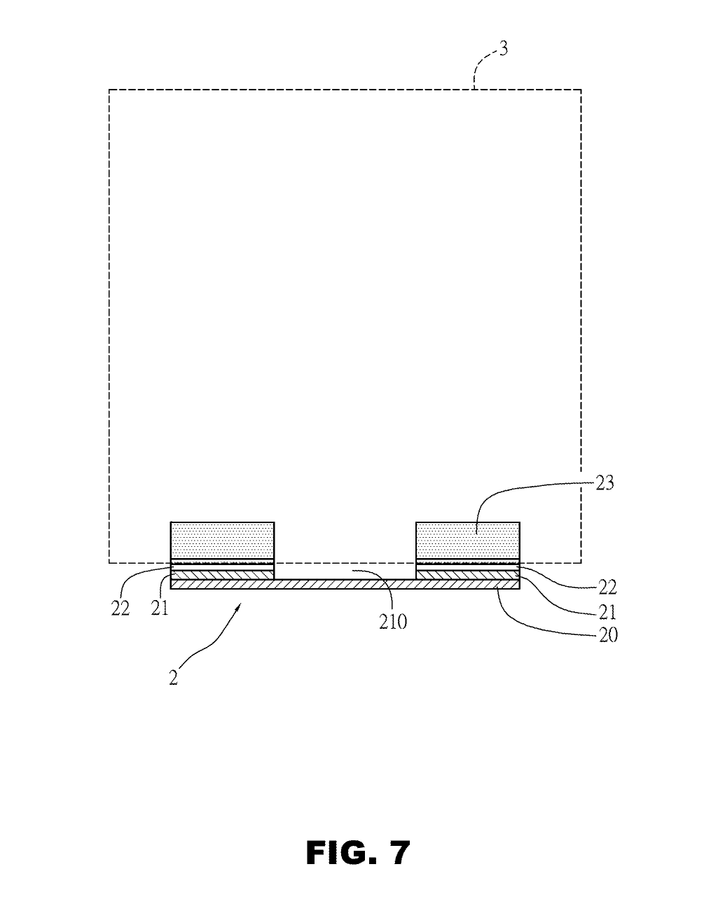

Referring to FIG. 7, it shows a front cutaway view of the present invention. The steel coil 3 is emplaced on the protection structure 2 and the weight of the steel coil 3 is supported respectively by the side seats 22 at two end sides of the bottom seat 20 to truly and stably locate two end sides of the steel coil 3. In addition, the width of the steel coil 3 should be larger than the width of the two foundation units 21, preventing the end sides of the steel coil 3 to be emplaced on the carrier blocks 23 directly that the stress on the end side of the steel coil 3 is concentrated on one point of the foundation unit 21 to deform and damage the foundation unit 21, and the weight of the steel coil 3 cannot be supported uniformly. Furthermore, the gap 210 that is formed deliberately between the two foundation units 21 can save the manufacturing cost of the protection structure 2 and can more uniformly support the weight of the steel coil 3 (which is about 200 tons), which is provided with a perfect performance of use. As the bottom seat 20, the foundation units 21, the side seats 22 and the carrier blocks 23 are stacked respectively to form the protection structure 2, when one part is damaged, it can be dismantled and replaced with a new and good part and is then assembled, without a need for renewing the entire protection structure, thereby reducing the cost of replacement and achieving a better economic benefit.

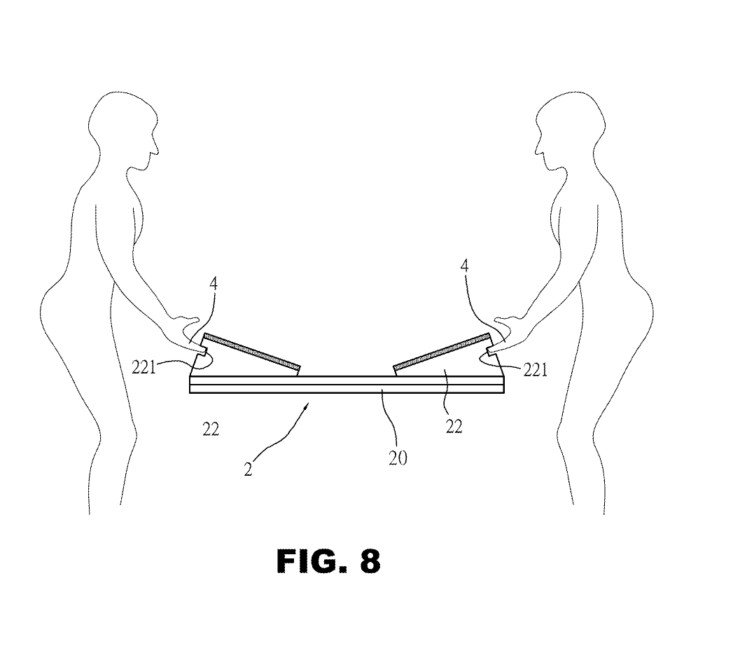

Referring to FIG. 8, it shows a schematic view of the present invention in transportation. When transporting, as the exterior sides of the side seats 22 are provided with the recesses 221, users can insert their hands 4 into the recesses 221 to lift up the two side seats 22 using the recesses 221 as points of application to transport the protection structure 2, which is very easy and convenient. In addition, as a supporting surface of the bottom seat 20 is stacked like a storage tank, the protection structure 2 can be transported as a whole set, which is considerably convenient in use.

Accordingly, in the present invention, the bottom seat serves as a basis and each part is stacked up to form a protection structure. Therefore, each damaged part can be dismantled separately to replace with a new and good part. In addition, the gap is formed between the two side seats, which saves the manufacturing cost of the protection structure and uniformly supports the weight of the steel coil. In particular, the exterior sides of the two side seats are provided with the recesses to facilitate users to transport the protection structure, which is considerably perfect and advance in use.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A steel coil protection structure comprising a bottom seat, foundation units, side seats and carrier blocks, wherein the bottom seat is a quadrilateral plate, two end sides of the bottom seat are provided respectively with the foundation unit to form a gap between the two foundation units, two end sides of the foundation unit are provided respectively with the side seat that is a triangular block, two side seats are tilted deliberately toward a center to form a bevel to result in a positioning groove between the two side, seats, and the carrier blocks are fixed above the bevels of the side seats.

2. The steel coil protection structure according to claim 1, wherein the side seat is provided with a recess.
